(19) United States
(12) Patent Application Publication
(10) Pub. No.: US 2024/0002752 A1
(43) Pub. Date: Jan. 4, 2024

(54) CONCENTRATED NON-AQUEOUS FABRIC CONDITIONERS

(71) Applicant: Conopco, Inc., d/b/a UNILEVER, Englewood Cliffs, NJ (US)

(72) Inventors: Balu Kunjupillai, Bangalore (IN); Gaurav Pathak, Bangalore (IN); Dhanalakshmi Thirumeni, Bangalore (IN)

(21) Appl. No.: 18/033,996

(22) PCT Filed: Oct. 25, 2021
(86) PCT No.: PCT/EP2021/079494

§ 371 Date: Apr. 26, 2023

(30) Foreign Application Priority Data
Nov. 11, 2020 (IN) 202021049329
Jan. 14, 2021 (EP) 21151685.1

(51) Int. Cl. C11D 3/00; C11D 11/00; C11D 3/30; C11D 3/18; C11D 3/43; C11D 3/50; C11D 17/04

(52) U.S. Cl. CPC C11D 3/0015; C11D 11/0017; C11D 3/30; C11D 3/18; C11D 3/43; C11D 3/505; C11D 11/0094; C11D 17/043

(57) ABSTRACT

A non-aqueous concentrated liquid fabric conditioner composition, the composition comprising; a. 10 to 85 wt. % ester linked quaternary ammonium compound; and b. solvent selected from; i. hydrocarbons comparing 5 to 19 carbon atoms; ii. solvents having a δ_{D} dispersion parameter of greater than 16.5 MPa^{1/2} and a δ_{P} polarity parameter of 2.5 to 8 MPa^{1/2}; and iii. mixtures thereof.

### FIELD OF INVENTION

The present invention is in the field of fabric conditioners, particularly providing concentrated non-aqueous fabric conditioner formulations.

### BACKGROUND OF THE INVENTION

There is a trend for consumer products to be increasingly concentrated. Concentration enables the use of less packaging and fewer chemicals. Smaller bottles or bottles containing more doses also provide convenience for the consumer.

In the field of fabric conditioners, concentration is a difficult problem to address. Fabric conditioners traditionally comprises quaternary ammonium compounds and more recently ester-linked quaternary ammonium compounds have dominated markets due to their bio-degradability. However, in fabric conditioner compositions, particularly aqueous compositions, as the concentration of ester linked quaternary ammonium compounds increases, so does the viscosity of the composition. At high concentrations, the products can become too thick to use or solidify.

There is an ongoing need for fabric conditioner compositions which can be formulated as concentrated products.

### SUMMARY OF THE INVENTION

In a first aspect of the present invention is provided a non-aqueous concentrated liquid fabric conditioner composition, the composition comprising;
a) 15 to 85 wt. % ester linked quaternary ammonium compound; and
b) Solvent selected from;
   i. Hydrocarbons comparing 5 to 19 carbon atoms;
   ii. Mixtures of hydrocarbons comparing 5 to 19 carbon atoms and solvents having a δ_{D} dispersion parameter of greater than 16.5 MPa^{1/2} and a δ_{P} polarity parameter of 2.5 to 8 MPa^{1/2}
c) less than 20 wt. % water.

In a second aspect of the present invention is provided a method of producing a non-aqueous concentrated fabric conditioner composition wherein the ester linked quaternary ammonium compound and solvent are heated together, to a temperature above 45° C. In a third aspect of the present invention is provided a method of using a composition as described herein, wherein the composition is diluted with water, prior to being added to the laundry process.

### DESCRIPTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### Fabric Softening Active

The compositions described herein comprise an ester-linked quaternary ammonium compound. The fabric conditioners of the present invention comprise more than 10 wt. % ester-linked quaternary ammonium compound, preferably more than 15 wt. % ester-linked quaternary ammonium compound, more preferably more than 25 wt. % ester-linked quaternary ammonium compound, most preferably more than 35 wt. % ester-linked quaternary ammonium compound, by weight of the composition. Preferably the fabric conditioners of the present invention comprise less than 85 wt. % ester-linked quaternary ammonium compound, more preferably less than 80 wt. % ester-linked quaternary ammonium compound, most preferably less than 70 wt. % ester-linked quaternary ammonium compound by weight of the composition. Suitably the fabric conditioners comprise 10 to 85 wt. % ester-linked quaternary ammonium compound, preferably 15 to 80 wt. % ester-linked quaternary ammonium compound, more preferably 25 to 70 wt. % ester-linked quaternary ammonium compound and most preferably 35 to 70 wt. % ester-linked quaternary ammonium compound by weight of the composition. Particularly preferred ranges may be 30 to 60 wt. % ester-linked quaternary ammonium compound and 50 to 80 wt. % ester-linked quaternary ammonium compound.

The ester-linked quaternary ammonium compound preferably comprises at least one chain derived from fatty acids, more preferably at least two chains derived from a fatty acids. Generally fatty acids are defined as aliphatic monocarboxylic acids having a chain of 4 to 28 carbons. Fatty acids may be derived from various sources such as tallow or plant sources. Preferably the fatty acid chains are derived from plants. Preferably the fatty acid chains of the ester-linked quaternary ammonium compound comprise from 10 to 50 wt. % of saturated C18 chains and from 5 to 40 wt. % of monounsaturated C18 chains by weight of total fatty acid chains. In a further preferred embodiment, the fatty acid chains of the ester-linked quaternary ammonium compound comprise from 20 to 40 wt. %, preferably from 25 to 35 wt. % of saturated C18 chains and from 10 to 35 wt. %, preferably from 15 to 30 wt. % of monounsaturated C18 chains, by weight of total fatty acid chains.

Particularly preferred materials are the ester-linked triethanolamine (TEA) quaternary ammonium compounds comprising a mixture of mono-, di- and tri-ester linked components.

Typically, TEA-based fabric softening compounds comprise a mixture of mono, di- and tri ester forms of the compound where the di-ester linked component comprises no more than 70 wt. % of the fabric softening compound, preferably no more than 60 wt. % e.g. no more than 55%, or even no more that 45% of the fabric softening compound and at least 10 wt. % of the monoester linked component.

A first group of ester-linked quaternary ammonium compounds suitable for use in the present invention is represented by formula (I):

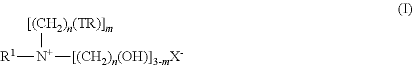

wherein each R is independently selected from a C5 to C35 alkyl or alkenyl group; R1 represents a C1 to C4 alkyl, C2 to C4 alkenyl or a C1 to C4 hydroxyalkyl group; T may be either O—CO. (i.e. an ester group bound to R via its carbon atom), or may alternatively be CO—O (i.e. an ester group bound to R via its oxygen atom); n is a number selected from 1 to 4; m is a number selected from 1, 2, or 3; and X— is an anionic counter-ion, such as a halide or alkyl sulphate, e.g. chloride or methylsulfate. Di-esters variants of formula I (i.e. m=2) are preferred and typically have mono- and tri-ester analogues associated with them. Such materials are particularly suitable for use in the present invention.

Suitable actives include soft quaternary ammonium actives such as Stepantex VT90, Rewoquat WE18 (ex-Evonik) and Tetranyl L1/90N, Tetranyl L190 SP and Tetranyl L190 S (all ex-Kao).

Also suitable are actives rich in the di-esters of triethanolammonium methylsulfate, otherwise referred to as “TEA ester quats”.

Commercial examples include Preapagen™ TQL (ex-Clariant), and Tetranyl™ AHT-1 (ex-Kao), (both di-[hardened tallow ester] of triethanolammonium methylsulfate), AT-1 (di-[tallow ester] of triethanolammonium methylsulfate), and L5/90 (di-[palm ester] of triethanolammonium methylsulfate), (both ex-Kao), and Rewoquat™ WE15 (a di-ester of triethanolammonium methylsulfate having fatty acyl residues deriving from C10-C20 and C16-C18 unsaturated fatty acids) (ex-Evonik).

A second group of ester-linked quaternary ammonium compounds suitable for use in the invention is represented by formula (II):

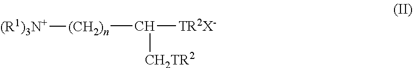

wherein each R1 group is independently selected from C1 to C4 alkyl, hydroxyalkyl or C2 to C4 alkenyl groups; and wherein each R2 group is independently selected from C8 to C28 alkyl or alkenyl groups; and wherein n, T, and X— are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding mono-ester.

A third group of ester-linked quaternary ammonium compounds suitable for use in the invention is represented by formula (III):

(R¹)₂—N⁺—[(CH₂)ₙ-T-R²]₂X⁻ (III)

wherein each R1 group is independently selected from C1 to C4 alkyl, or C2 to C4 alkenyl groups; and wherein each R2 group is independently selected from C8 to C28 alkyl or alkenyl groups; and n, T, and X— are as defined above. Preferred materials of this third group include bis(2-tallowoyloxyethyl)dimethyl ammonium chloride, partially hardened and hardened versions thereof.

A particular example of the fourth group of ester-linked quaternary ammonium compounds is represented the by the formula:

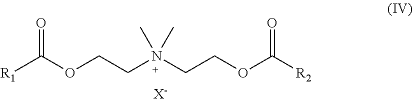

A fifth group of ester-linked quaternary ammonium compounds suitable for use in the invention are represented by formula:

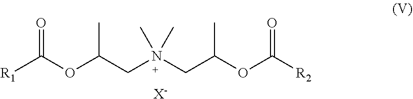

R1 and R2 are independently selected from C10 to C22 alkyl or alkenyl groups, preferably C14 to C20 alkyl or alkenyl groups. X— is as defined above.

The iodine value of the ester-linked quaternary ammonium compound fabric conditioning material is preferably from 0 to 80, more preferably from 0 to 60, and most preferably from 0 to 45. The iodine value may be chosen as appropriate. Essentially saturated material having an iodine value of from 0 to 5, preferably from 0 to 1 may be used in the compositions of the invention. Such materials are known as “hardened” quaternary ammonium compounds.

A further preferred range of iodine values is from 20 to 60, preferably 25 to 50, more preferably from 30 to 45. A material of this type is a “soft” triethanolamine quaternary ammonium compound, preferably triethanolamine di-alkylester methylsulfate. Such ester-linked triethanolamine quaternary ammonium compounds comprise unsaturated fatty chains.

If there is a mixture of ester-linked quaternary ammonium compound materials present in the composition, the iodine value, referred to above, represents the mean iodine value of the parent fatty acyl compounds or fatty acids of all of the quaternary ammonium materials present. Likewise, if there is any saturated ester-linked quaternary ammonium compound materials present in the composition, the iodine value represents the mean iodine value of the parent acyl compounds of fatty acids of all of the quaternary ammonium materials present.

Iodine value as used in the context of the present invention refers to, the fatty acid used to produce the ester-linked quaternary ammonium compound, the measurement of the degree of unsaturation present in a material by a method of nmr spectroscopy as described in Anal. Chem., 34, 1136 (1962) Johnson and Shoolery.

### Solvent

The compositions as described herein comprise a solvent selected from:
i. Hydrocarbons comparing 5 to 19 carbon atoms;
ii. Mixtures of hydrocarbons comparing 5 to 19 carbon atoms and solvents having a δ_{D} dispersion parameter of greater than 16.5 MPa^{1/2} and a δ_{P} polarity parameter of 2.5 to 8 MPa^{1/2}.

The selection of these specific solvents enables the formulation of a concentrated, non-aqueous fabric conditioning composition comprising ester linked quaternary ammonium compounds. Other solvents result in solidification of the compositions, which renders it unusable.

The hydrocarbon solvents may be straight chain hydrocarbons or branched hydrocarbons. Preferably they are straight chain hydrocarbons. The hydrocarbons may be saturated or unsaturated. Preferably the hydrocarbons are saturated. Preferably the hydrocarbon solvent comprises 5 to 15 carbon atoms.

The solvents may additionally include solvents having δ_{D} dispersion parameter of greater than 16.5 MPa^{1/2} and a δ_{P} polarity parameter of 2.5 to 8 MPa^{1/2}. These parameters are available in the literature or may be calculated using software such as Hansen Solubility Parameters in Practice (HSPiP). Preferably the δ_{D} dispersion parameter is greater than 18 MPa^{1/2} this results in a clear or isotropic composition. Preferably the δ_{D} dispersion parameter is less than 25 MPa^{1/2}. Preferably the δ_{P} polarity parameter is 3.8 to 7.8 MPa^{1/2}, more preferably 4.5 to 7 MPa^{1/2 2} this results in a clear or isotropic composition. Preferably the solvent is organic. Examples of suitable solvents are provided on Table 3.

Preferably the composition comprises 5 to 80 wt. % of the solvent described herein. More preferably 20 to 70 wt. % solvent and most preferably 25 to 65 wt. % solvent.

Other solvents may be present in addition to the solvents described herein.

### Perfume

The compositions as described herein preferably comprise perfume. Where present, the compositions preferably comprise 0.1 to 30 wt. % perfume, i.e. free perfume and/or perfume microcapsules. As is known in the art, free perfumes and perfume microcapsules provide the consumer with perfume hits at different points during the laundry process. It is particularly preferred that the compositions of the present invention comprise a combination of both free perfume and perfume microcapsules.

Preferably the compositions of the present invention comprise 0.5 to 30 wt. % perfume materials, more preferably 1 to 20 wt. % perfume materials, most preferably 1 to 15 wt. % perfume materials.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

The compositions of the present invention preferably comprise 0.5 to 20 wt. % free perfume, more preferably 0.5 to 12 wt. % free perfume.

Particularly preferred perfume components are blooming perfume components and substantive perfume components. Blooming perfume components are defined by a boiling point less than 250° C. and a Log P or greater than 2.5. Substantive perfume components are defined by a boiling point greater than 250° C. and a Log P greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

The compositions of the present invention preferably comprise 0.5 to 20 wt. % perfume microcapsules, more preferably 0.5 to 12 wt. % perfume microcapsules. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The compositions of the present invention preferably comprise friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a Log P greater than 2.5.

Preferably the encapsulated perfume compositions comprises at least 20 wt. % blooming perfume ingredients, more preferably at least 30 wt. % and most preferably at least 40 wt. % blooming perfume ingredients. Substantive perfume components are defined by a boiling point greater than 250° C. and a Log P greater than 2.5. Preferably the encapsulated perfume compositions comprises at least 10 wt. % substantive perfume ingredients, more preferably at least 20 wt. % and most preferably at least 30 wt. % substantive perfume ingredients. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

### Other Ingredients

The compositions for use as described herein may comprise other ingredients of fabric conditioner liquids as will be known to the person skilled in the art. Among such materials there may be mentioned: antifoams, insect repellents, shading or hueing dyes, preservatives (e.g. bactericides), anti-viral agents, pH buffering agents, perfume carriers, hydrotropes, anti-redeposition agents, soil-release agents, polyelectrolytes, anti-shrinking agents, anti-wrinkle agents, anti-oxidants, dyes, colorants, sunscreens, anti-corrosion agents, drape imparting agents, anti-static agents, sequestrants and ironing aids. The products of the invention may contain pearlisers and/or opacifiers. A preferred sequestrant is HEDP, an abbreviation for Etidronic acid or 1-hydroxyethane 1,1-diphosphonic acid.

### Form of the Composition

The compositions are non-aqueous, however some water may be present. Preferably less than 20 wt. % water, more preferably less than 10 wt. % water and most preferably, less than 5 wt. % water.

The compositions described herein are preferably an isotropic liquid. In an isotropic liquid, there are no visible particles and no light scattering. An isotropic liquid can be identified by turbidity. Turbidity can be measured using Turbidimeters such as the Turbiquant 1500 T ex. Merck. Preferably the compositions have a turbidity measurement of less than 2, more preferably less than 1.5, most preferably less than 1.3 NTU (Nephelometric Turbidity Units).

### Use

The compositions described herein are preferably used in the rinse stage of the laundry process. They may be used in their concentrated form and dosed into the laundry process. The composition may be dosed into the laundry process using a measuring cap, a pipet, a dropper or any other suitable dosing means. Preferably the composition is dosed into the rinse stage of the laundry process.

Preferably the concentrated compositions described herein may be used in unit dose capsules or in a dilute at home product.

If used in a unit dose capsule, the composition described herein may be packaged as a unit dose in polymeric film soluble in water.

If used in a dilute at home product, this means that the composition is sold to the consumer in a concentrated format (as described herein) and the consumer dilutes the product at home. The dilution is with water. For example, the consumer may pour the concentrated product (as described herein) into a container of water to make a more diluted product. Dilution allows the consumer to follow their regular dosing habits. If the composition is used in a dilute at home product, preferably the consumer is instructed to dilute using a dilution ratio of non-aqueous concentrated liquid fabric conditioner composition to water of 1:2 to 1:20, more preferably 1:3 to 1:12.

The consumer may preferably be instructed the shake before use. This is particularly preferred if perfume microcapsules are present in the composition.

Diluting with water prior to being added to the laundry process means that before adding the product to the washing machine or the vessel used for hand washing. i.e. the consumer dilutes the product and then adds it to the drum or drawer of a washing machine of the vessel used for hand washing.

### Method of Production

The compositions described herein are preferably manufactured by melting the ester linked quaternary ammonium compound in the presence of the solvent defined herein. To melt the ester linked quaternary ammonium, the ester linked quaternary ammonium compound and solvent are preferably heated to a temperature above 45° C., more preferably above 50° C. and most preferably about 55° C. Any perfume ingredients or other ingredients present in the final composition may be added at any stage; before heating, of while at the raised temperature, or after the composition has cooled down.

### EXAMPLES

### Example 1

The effect of various solvents in the example composition of table 1 were compared.

TABLE 1
Example composition

| | wt. % |
|---|---|
| | active |
| Ester linked quaternary ammonium compound¹ | 60 |
| Solvent² | 34 |
| Perfume oil | 6 |

Ester linked quaternary ammonium compound¹—TEA quaternary ammonium compound according to formula (I) above
Solvent²—As defined in tables 2 and 3

The example compositions were all prepared according to the following method. The ester linked quaternary ammonium compound, solvent and perfume oil were heated together to a temperature of 60° C. with stirring. Once fully mixed the composition was cooled to ambient temperature.

The compositions were left at ambient temperature overnight and visual observations were made of each composition the next day. The results are provided in tables 2 and 3.

TABLE 2
Hydrocarbon solvents

| Composition | | Number of | |
|---|---|---|---|
| number | Solvent | carbons | Observation |
| 1 | Hydrocarbons having carbon | C6-C13 | Isotropic liquid |
| | numbers predominantly in | | |
| | the range of C6 to C13 | | |
| 2 | C15-19 Alkane | C15-19 | Isotropic liquid |
| 3 | Isohexadecane | C16 | Translucent |
| | | | liquid |
| A | Saturated hydrocarbons | C15-C50 | Solid |
| | having carbon numbers | | |
| | predominantly in the | | |
| | range of C15 to 50 | | |

TABLE 3
Solvents

| | | Dispersion | Polar | |
|---|---|---|---|---|
| Composition | | component: | component | |
| number | Solvent | δ D (MPa^{1/2}) | δ P (MPa^{1/2}) | Observation |
| 4 | Butylphthalimide, | 19.6 | 6.7 | Clear isotropic |
| | Isopropylphthalimide | | | solution |
| 5 | C12-15 Alkyl Benzoate | 19.6 | 6.3 | Clear isotropic |
| | (and) Dipropylene | | | solution |
| | Glycol Dibenzoate (and) | | | |
| | PPG-15 Stearyl Ether | | | |
| | Benzoate | | | |
| 6 | Phenethyl Benzoate | 18.5 | 4.7 | Translucent |
| | | | | liquid |
| 7 | Benzyl alcohol | 18.4 | 6.3 | Clear isotropic |
| | | | | solution |
| B | Propylene carbonate | 18 | 22.4 | Solid |
| C | Ethylene glycol | 17.8 | 13.5 | Solid |
| D | PEG 6000 | 17.8 | 13.5 | Solid |
| E | Mono propylene glycol | 17.3 | 10.2 | Solid |
| 8 | Silicone oil | 17.2 | 2.9 | Opaque liquid |
| 9 | PPG-14 Butyl Ether | 17 | 4.1 | Opaque liquid |
| F | Nonionic silicone | 17 | 2 | Solid |
| | emulsion of a high | | | |
| | viscosity | | | |
| | polydimethylsiloxane. | | | |
| G | Methyl Levulinate | 16.8 | 8.4 | Solid |
| 10 | Pentylene Glycol | 16.8 | 7.8 | Opaque liquid |
| 11 | Hexylene glycol/2- | 16.7 | 6.9 | Opaque liquid |
| | methyl-2,4-pentanediol | | | |
| H | PEG 200 | 16.5 | 9 | Solid |
| I | Methyl laurate | 16.4 | 6 | Solid |
| J | Glyceryl trioctanoate | 16.4 | 3.2 | Solid |
| K | Tri(propylene glycol) | 16 | 6.7 | Solid |
| | butyl ether | | | |
| L | Dipropylene glycol di | 15.8 | 3.8 | Solid |
| | butyl ether | | | |
| M | PPG-3 Benzyl Ether | 15.8 | 2.5 | Solid |
| | Ethylhexanoate | | | |
| N | Cyclopentasiloxane | 11.8 | 0.7 | Solid |

As demonstrated in tables 2 and 3, the solvents described herein provide a liquid non-aqueous fabric conditioner, whereas other solvents result in solidified products.

### Example 2

The effect of the concentration of ingredients in the example composition was compared and the results provided in table 4. All compositions were prepared as described in Example 1. The compositions were left overnight in ambient conditions before the observations were made.

TABLE 4
Example compositions

| | wt. % active | | | | | |
|---|---|---|---|---|---|---|
| | Ester linked | | | | | |
| | quaternary | Solvent | | | | |
| Composition | ammonium | C6-C13 | Benzyl | C15-19 | Perfume | |
| number | compound¹ | hydrocarbon | alcohol | hydrocarbon | oil | Observation |
| 12 | 10 | 89 | — | — | 1 | Clear isotropic |
| 13 | 10 | — | 89 | — | 1 | Clear isotropic |
| 14 | 10 | — | — | 89 | 1 | Clear isotropic |
| 15 | 20 | 78 | — | — | 2 | Clear isotropic |
| 16 | 20 | — | 78 | — | 2 | Clear isotropic |
| 17 | 20 | — | — | 78 | 2 | Clear isotropic |
| 18 | 30 | 67 | — | — | 3 | Clear isotropic |
| 19 | 30 | — | 67 | — | 3 | Clear isotropic |
| 20 | 30 | — | — | 67 | 3 | Clear isotropic |
| 21 | 40 | 56 | — | — | 4 | Clear isotropic |
| 22 | 40 | — | 56 | — | 4 | Clear isotropic |
| 23 | 40 | — | — | 56 | 4 | Clear isotropic |
| 24 | 50 | 45 | — | — | 5 | Clear isotropic |
| 25 | 50 | — | 45 | — | 5 | Clear isotropic |
| 26 | 50 | — | — | 45 | 5 | Clear isotropic |
| 27 | 60 | 34 | — | — | 6 | Clear isotropic |
| 28 | 60 | — | 34 | — | 6 | Clear isotropic |
| 29 | 60 | — | — | 34 | 6 | Clear isotropic |
| 30 | 70 | 23 | — | — | 7 | Clear isotropic |
| 31 | 70 | — | 23 | — | 7 | Clear isotropic |
| 32 | 70 | — | — | 23 | 7 | Clear isotropic |
| 33 | 80 | 12 | — | — | 8 | Translucent |
| 34 | 80 | — | 12 | — | 8 | Opaque liquid |
| 35 | 80 | — | — | 12 | 8 | Opaque liquid |
| O | 90 | 1 | — | — | 9 | Solid |
| P | 90 | — | 1 | — | 9 | Solid |
| Q | 90 | — | — | 1 | 9 | Solid |

Table 4 demonstrates that the solvents as described herein, can produce stable clear isotropic formulations across a range of compositions.

1. A non-aqueous concentrated liquid fabric conditioner composition, the composition comprising;
a) 35 to 80 wt. % ester linked quaternary ammonium compound; and
b) 20 to 65 wt. % Solvent selected from;
i. Hydrocarbons comprising 5 to 19 carbon atoms;
ii. Mixtures of hydrocarbons comparing 5 to 19 carbon atoms and solvents having a δ_{D} dispersion parameter of greater than 16.5 MPa^{1/2} and a δ_{P} polarity parameter of 2.5 to 8 MPa^{1/2}; and
c) less than 20 wt. % water.

2. A composition according to claim 1, wherein the composition comprises 25 to 65 wt. % of the solvent (b).

3. A composition according to claim 1, wherein the composition comprises Solvent selected from;
i. Hydrocarbons comprising 5 to 19 carbon atoms;
ii. Mixtures of hydrocarbons comprising 5 to 19 carbon atoms and solvents having a δ_{D} dispersion parameter of greater than 18 MPa^{1/2} and a δ_{P} polarity parameter of 2.5 to 8 MPa^{1/2}.

4. A composition according to claim 1, wherein the composition comprises Solvent selected from;
i. Hydrocarbons comprising 5 to 19 carbon atoms;
ii. Mixtures of hydrocarbons comprising 5 to 19 carbon atoms and solvents having a δ_{D} dispersion parameter of greater than 16.5 MPa^{1/2} and a δ_{P} polarity parameter of 4.5 to 7 MPa^{1/2}.

5. A composition according to claim 1, wherein the composition comprises Solvent selected from;
i. Hydrocarbons comprising 5 to 19 carbon atoms;
ii. Mixtures of hydrocarbons comprising 5 to 19 carbon atoms and solvents having a D dispersion parameter of greater than 18 MPa^{1/2} and a δ_{P} polarity parameter of 4.5 to 7 MPa^{1/2}.

6. A composition according to claim 1, wherein the composition further comprises perfume oil.

7. A composition according to claim 1, wherein the composition further comprises 0.5 to 20 wt. % perfume microcapsules.

8. A composition according to claim 1, wherein the composition is isotropic.

9. A composition according to claim 1, wherein the composition has a turbidity measurement of less than 2 NTU.

10. A composition according to claim 1, wherein the composition is packaged as a unit dose in a polymeric film soluble in water.

11. A method of producing a non-aqueous concentrated fabric conditioner composition wherein the ester linked quaternary ammonium compound and solvent are heated together, to a temperature above 45° C.

12. A method of using a composition according to claim 1, wherein the composition is diluted with water, prior to being added to the laundry process.

13. A method according to claim 11, wherein the composition is diluted with water with a dilution ratio of non-aqueous concentrated liquid fabric conditioner composition to water of 1:2 to 1:20.
